(19) United States
(12) Patent Application Publication
(10) Pub. No.: US 2026/0059301 A1
(43) Pub. Date: Feb. 26, 2026

(54) PHYSICAL LAYER SECURITY FOR INTEGRATED SENSING AND COMMUNICATION

(71) Applicant: Apple Inc., Cupertino, CA (US)

(72) Inventors: Chunxuan Ye, San Diego, CA (US); Dawei Zhang, Saratoga, CA (US); Haijing Hu, Los Gatos, CA (US); Haitong Sun, Saratoga, CA (US); Huarui Liang, Beijing (CN); Lanpeng Chen, Beijing (CN); Oghenekome Oteri, San Diego, CA (US); Shu Guo, Beijing (CN); Wei Zeng, Saratoga, CA (US); Xiaoyu Qiao, Beijing (CN)

(73) Assignee: Apple Inc., Cupertino, CA (US)

(21) Appl. No.: 19/245,101

(22) Filed: Jun. 20, 2025

Related U.S. Application Data
(60) Provisional application No. 63/685,672, filed on Aug. 21, 2024.

(51) Int. Cl. H04W 12/02; G01S 7/00; G01S 13/86

(52) U.S. Cl. CPC H04W 12/02; G01S 7/006; G01S 13/86

(57) ABSTRACT

The present application relates to devices and components including apparatuses, systems, and methods for sensing-assisted beamforming for security.

### CROSS-REFERENCE TO RELATED APPLICATION

This application claims priority to U.S. Provisional Patent Application No. 63/685,672, entitled “PHYSICAL LAYER SECURITY FOR INTEGRATED SENSING AND COMMUNICATION,” filed on Aug. 21, 2024, which is herein incorporated by reference in its entirety for all purposes.

### TECHNICAL FIELD

This application relates generally to communication networks and, in particular, to physical layer security for integrated sensing and communication in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates a bi-static sensing model and a mono-static sensing model in accordance with various embodiments herein.

FIG. 3 illustrates an example procedure for base station mono-static sensing-assisted beam forming for security, in accordance with various embodiments.

FIG. 4A illustrates an example implementation of base station mono-static sensing-assisted beam forming, in accordance with some embodiments.

FIG. 4B illustrates another example implementation of base station mono-static sensing-assisted beam forming, in accordance with some embodiments.

FIG. 4C illustrates another example implementation of base station mono-static sensing-assisted beam forming, in accordance with some embodiments.

FIG. 5 illustrates an example procedure for user equipment (UE) mono-static sensing-assisted beam forming for security, in accordance with various embodiments.

FIG. 6 illustrates an example implementation of UE mono-static sensing-assisted beam forming, in accordance with various embodiments.

FIG. 7 illustrates an example procedure for base station-UE bi-static or UE-base station bi-static sensing-assisted beam forming for security, in accordance with various embodiments.

FIG. 8 illustrates an example implementation of base station-UE bi-static or UE-base station bi-static sensing-assisted beam forming in accordance with various embodiments.

FIG. 9 illustrates an operational flow/algorithmic structure in accordance with some embodiments.

FIG. 10 illustrates another operational flow/algorithmic structure in accordance with some embodiments.

FIG. 11 illustrates a user equipment in accordance with some embodiments.

FIG. 12 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

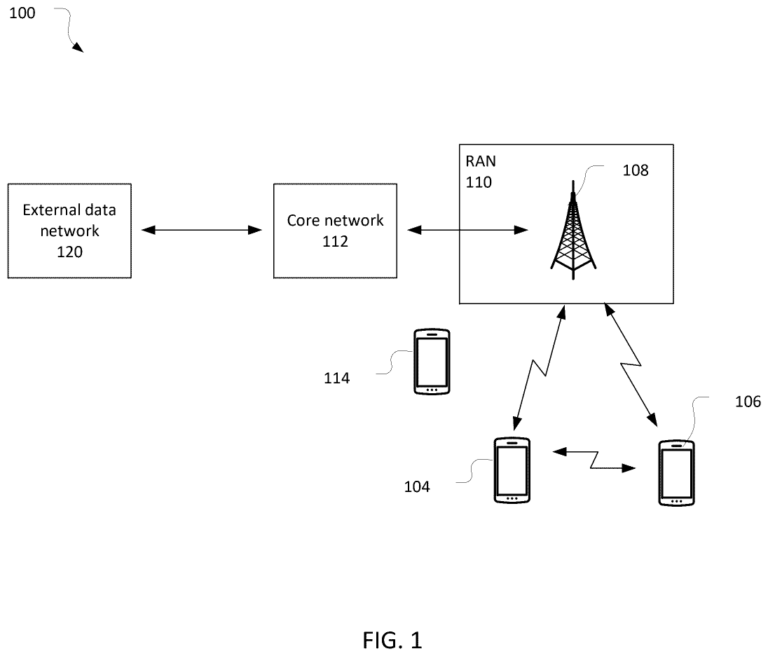

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP Technical Specifications (TSs) such as those that define a Fifth Generation (5G) new radio (NR) system or a later system. The base station 108 may provide user plane and control plane protocol terminations toward the UE 104. The UE 104 may connect with the RAN 110 to access an external data network 120.

In some embodiments, the base station 108 may correspond to a next generation NodeB (gNB). Additionally, or alternatively, the base station 108 may include one or more transmission-reception points (TRPs) to transmit and receive signals (e.g., signals to and from UE 104 and/or the sensing signals described herein).

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

In embodiments, the base station 108, UE 104, and/or UE 106 may perform sensing operations to detect and/or track objects in the environment. For example, the sensing operations may be in accordance with integrated sensing and communication (ISAC) protocols developed in 3GPP. The sensing operations may generally include transmitting a sensing signal, receiving the sensing signal, and processing the received sensing signal to generate sensing information (also referred to as sensing results) that indicates the presence and/or location of objects in the environment. Various sensing models have been developed, including mono-static sensing, in which the same device transmits and receives the sensing signal, and bi-static sensing, in which one device transmits the sensing signal and another device receives the sensing signal.

Various embodiments herein relate to using sensing information to improve security of communication. For example, the sensing information may be used to detect the presence, direction, and/or location of an eavesdropper 114 (referred to herein as “Eve” 114). The location and/or direction of the UE 104 (referred to as the “target UE”) may also be determined based on the sensing information. Using the sensing information may enable more accurate determination of the location and/or direction of the UE 104 than prior techniques.

In various embodiments, the base station 108 may determine beamforming information for communication with the UE 104 based on the sensing information. For example, the beamforming information may correspond to a new transmit (Tx) beam (e.g., used by the base station 108 to transmit signals to the UE 104 and/or used by the UE 104 to transmit signals to the base station 108) and/or receive (Rx) beam (e.g., used by the UE 104 to receive signals from the base station 108 and/or used by the base station 108 to receive signals from the UE 104). While embodiments herein are described with reference to downlink transmissions from the base station 108 to the UE 104, aspects of various embodiments may be used for uplink transmissions from the UE 104 to the base station 108 and/or sidelink communication between the UE 104 and the UE 106.

The new Tx beam and/or Rx beam may be different than the Tx beam and/or Rx beam that were selected as part of the beam management procedure (e.g., synchronization signal block (SSB)-based beam management or channel state information-reference signal (CSI-RS)-based beam management). The determination of the beamforming information based on the sensing information may prevent or reduce the likelihood of Eve 114 being able to receive the signal, thereby increasing physical layer (PHY) security.

In some embodiments, the transition to the new Tx beam may be transparent to the UE 104. Accordingly, the base station 108 does not need to notify the UE 104 of the new Tx beam and the UE 104 can continue to use the existing Rx beam (e.g., that was selected during the beam management procedure). In other embodiments, such as when the Rx beam is to be changed, the base station 108 notifies the UE 104 of the updated beam information.

In other embodiments, or under some circumstances, the base station 108 may pause data transmission to the UE 104 based on the sensing information. For example, the data transmission may be paused if the transmission or the UE 104 has a relatively high security level (e.g., at a threshold level or greater), and/or if it is determined that another suitable Tx beam and/or Rx beam (e.g., for which Eve 114 is not detected) is not available.

The techniques described herein may be used with any suitable sensing model, including mono-static sensing and bi-static sensing. For example, the techniques may be used with base station mono-static sensing, UE mono-static sensing, base station-UE bi-static sensing, UE-base station bi-static sensing, base station-base station bi-static sensing (including TRP-TRP bi-static sensing in which the TRPs are associated with the same base station), and UE-UE bi-static sensing.

Various embodiments herein further relate to techniques for the UE 104 to report sensing information to the base station 108. For example, the UE 104 may report the sensing information jointly with beam reporting or separate from beam reporting. In embodiments, different procedures and signaling may be used depending on the sensing model that is used.

In 3GPP release (Rel)-19, there is a study item of channel modelling for ISAC. Features related to ISAC may be adopted into future specifications, such as for 5G and/or 6G. Some objectives for 3GPP Rel-19 Integrated Sensing and Communications (ISAC) Study Item (SI) (see RP-234069) are described below.

The focus of the study is to define channel modelling aspects to support object detection and/or tracking (as per the SA1 meaning in 3GPP TS 22.137). The study should aim at a common modelling framework capable of detecting and/or tracking the following example objects and to enable them to be distinguished from unintended objects:
UAVs
Humans indoors and outdoors
Automotive vehicles (at least outdoors)
Automated guided vehicles (e.g. in indoor factories)
Objects creating hazards on roads/railways, with a minimum size dependent on frequency

All six sensing modes are considered (e.g. transmission-reception point (TRP)-TRP bistatic, TRP monostatic, TRP-UE bistatic, UE-TRP bistatic, UE-UE bistatic, UE monostatic). Frequencies from 0.5 to 52.6 GHz are the primary focus, with the assumption that the modelling approach should scale to 100 GHz. (If significant problems are identified with scaling above 52.6 GHz, the range above 52.6 GHz can be deprioritized.) For the above use cases, sensing modes and frequencies, objectives include to:
Identify details of the deployment scenarios corresponding to the above use cases.
Define channel modelling details for sensing using 3GPP TS 38.901 as a starting point, and taking into account relevant measurements, including:
   modelling of sensing targets and background environment, including, for example (if needed by the above use cases), radar cross-section (RCS), mobility and clutter/scattering patterns;
   spatial consistency.

In the International Mobile Telecommunications (IMT)-2030 framework, the integration of sensing and communication is expected to become a key enabler for a wide range of use cases. Moreover, sensing the physical surroundings together with appropriate artificial intelligence (AI) could further enhance situational awareness.

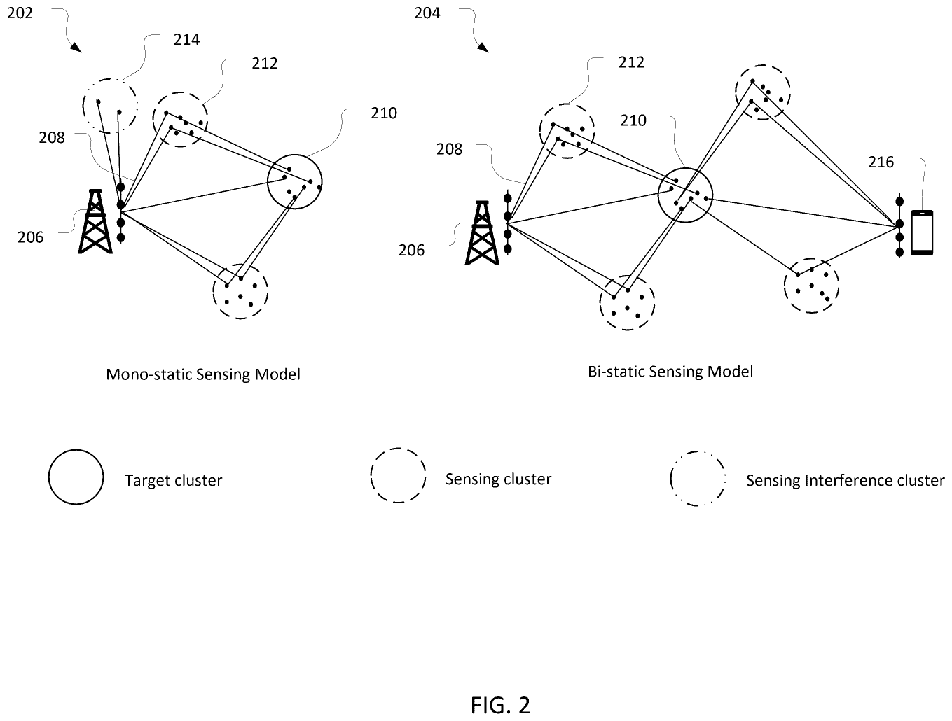

FIG. 2 illustrates a mono-static sensing model 202 and a bi-static sensing model 204 in accordance with various embodiments herein. It is noted that the mono-static sensing model 202 is shown and described with reference to base station mono-static sensing. However, similar techniques may be used for UE mono-static sensing. Additionally, the bi-static sensing model 202 is shown and described with reference to base station-UE bi-static sensing. However, similar techniques may be used for other types of bi-static sensing.

As shown, in the mono-static sensing model 202, a base station 206 may transmit a sensing signal 208 into the surrounding environment. The environment may include a target cluster 210 that corresponds to an object that is to be detected, as well as sensing clusters 212 which correspond to other objects that are present in the environment. The environment may further include a sensing interference cluster 214 that corresponds to a source of interference. The base station 206 may receive the sensing signal 208 after it has reflected off the target cluster 210 (e.g., in some cases, via a sensing cluster 212). The base station 206 generates sensing information based on the received sensing signal 208. The sensing information may indicate the presence and/or location of the target cluster 210.

The bi-static sensing model 204 may involve a second device to receive the sensing signal, which in the model of base station-UE bi-static sensing shown in FIG. 2 is a UE 216. The base station 206 transmits a sensing signal 208. The UE 216 receives the sensing signal 208 after it has reflected off target cluster 210 (e.g., via a sensing cluster 212). The UE 208 generates sensing information based on the received sensing signal 208. The sensing information may indicate the presence and/or location of the target cluster 210.

Sensing-assisted communications such as ISAC may have impacts on security of the associated communications. For example, the transmission of the sensing signal may expose the communications signal to Eve. However, as disclosed herein, the sensing may also be used to enhance security of the communications, e.g., sensing-assisted PHY security. Secure ISAC transmission methods may address the conflicting objectives of illuminating signal energy to the radar target, while at the same time constraining the useful signal energy (e.g., signal-to-noise ratio (SNR)) towards the same direction of the sensed target, e.g., to inhibit its capability to eavesdrop the information signal sent to the communication users. The sensing capability can provide an enabling role for PHY security, where the sensing information (e.g., detected Eve's location and/or direction (such as indicated by angle of arrival (AoA)) may be used to enable null steering and secure beamforming.

Some example techniques for sensing-assisted beam forming for security are described further below. For example, techniques are described for base station mono-static sensing, UE mono-static sensing, and bi-static sensing. It will be apparent that these techniques are provided as examples, and suitable modifications may be made in accordance with various embodiments.

### TRP Mono-Static Sensing-Assisted Beam Forming

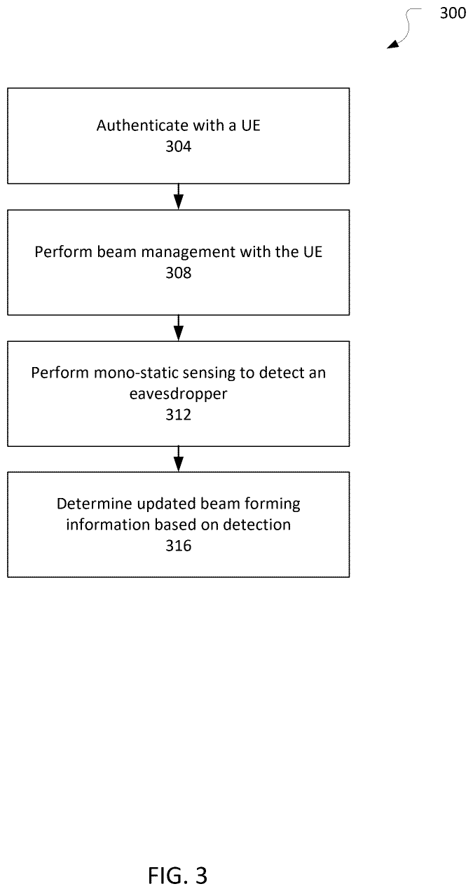

FIG. 3 illustrates an example procedure 300 for base station mono-static sensing-assisted beam forming, in accordance with various embodiments. The procedure 300 may be performed by a base station (e.g., base station 108). Corresponding operations may be performed by a UE (e.g., UE 104).

At 304, the procedure 300 may include to authenticate with a UE (e.g., UE 104). The authentication may include configuring a security level associated with the sensing-assisted beam forming. As discussed further below, the security level may be used to determine whether to take an action in response to detection of Eve and/or to determine the action to take in response to the detection.

At 308, the procedure 300 may include to perform beam management with the UE. For example, the beam management may include SSB-based beam management or CSI-RS-based beam management. Performing the beam management may include determining beam information to use for communication with the UE. The beam information may correspond to a Tx beam and an Rx beam.

For example, the UE may perform measurements associated with a respective Tx beams and/or Rx beams and transmit a report to the base station with the measurements. For example, the measurements may include a reference signal received power (RSRP), such as a layer 1 (L1)-RSRP. The measurements may be performed on a respective SSB or CSI-RS. The base station may select a Tx beam and/or Rx beam to use based on the report. Additionally, the base station may transmit an indication of the selected Rx beam to the UE.

At 312, the procedure 300 may include to perform mono-static sensing to detect an eavesdropper (Eve). For example, the base station may transmit a sensing signal, receive the sensing signal after it reflects off Eve and/or other objects in the environment, and process the received sensing signal to detect Eve. The base station may generate sensing information associated with Eve based on the received sensing signal. For example, the sensing information may indicate a location (e.g., two-dimensional and/or three-dimensional coordinates), a direction (e.g., AoA), a type of object, and/or a physical feature of Eve (e.g., size, shape, etc.).

In some embodiments, the base station may also determine sensing information (e.g., location and/or direction) of the target UE using sensing. The sensing information may be more precise and/or accurate than is available via beam management.

In embodiments, the base station may identify a device as a potential Eve based on the received sensing signal. The base station may attempt to authenticate the device. If the device is successfully authenticated, then it may not be considered an Eve. However, if the device is not successfully authenticated, the base station may consider the device to be an Eve.

At 316, the procedure 300 may include to determine updated beam forming information for the UE based on the detected Eve. For example, the updated beam forming information may include an updated Tx beam and/or an updated Rx beam. The updated beam forming information may direct the Tx beam and/or Rx beam to prevent and/or reduce the likelihood of Eve receiving the associated communication signal. For example, the updated beam forming information may null the Tx beam toward Eve and direct the updated Tx beam away from Eve while still enabling sufficient communication with the UE. In some embodiments, the updated beam forming information may correspond to a candidate beam (e.g., Tx beam and/or Rx beam) that has a best signal quality (e.g., RSRP) among candidate beams for which the Eve is not detected.

In some embodiments, the updated beam forming information may correspond to degradation of received signal quality (e.g., RSRP) at the UE compared with the prior beam forming information generated as part of beam management (at 308). However, this may be an acceptable tradeoff to avoid leakage of communications to Eve.

In some embodiments, the updated beam forming information may be determined further based on the sensing information that indicates the position of the UE. This may enable the base station to determine beam forming information that more precisely targets the communications to the UE without leaking the communications to Eve.

In some embodiments, the base station may perform operation 316 (e.g., determine the updated beam forming information) based on a security level of the UE and/or an associated communication (e.g., data transmission). For example, the base station may determine the updated beam forming information for a relatively high security level but may continue to use the prior beam forming information (e.g., from the beam management at 308) for a relatively low security level. Additionally, or alternatively, the updated beam forming information may be used for a subset of transmissions to the UE. For example, the updated beam forming information may be used for data transmissions to the UE (e.g., all data transmissions or data transmissions that have a relatively high security level). The prior beam forming information may continue to be used for one or more other types of transmissions to the UE, such as CSI-RS, data transmissions with a relatively low security level, control information (e.g., physical downlink control channel (PDCCH)), etc.

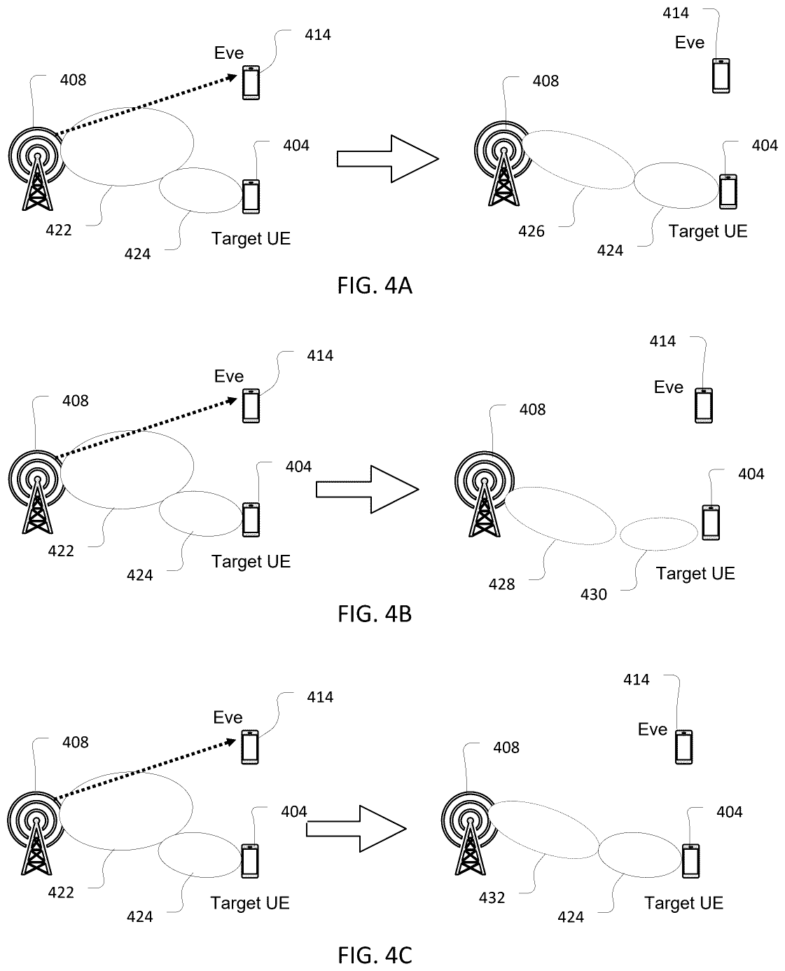

In various embodiments, the transition to the updated beam information may be transparent or non-transparent to the UE. FIGS. 4A-4C schematically illustrate some example implementations in accordance with various embodiments. The left side of each of FIGS. 4A-4C illustrates a base station 408 in communication with a UE 404 using a Tx beam 422 and an Rx beam 424. The base station detects the presence of Eve 414. The right side of FIGS. 4A-4C illustrate example actions that may be taken in response to the detection of Eve 414.

For example, as shown in FIG. 4A, the base station 408 may update the Tx beam from Tx beam 422 to Tx beam 426, but may not update the Rx beam 424. The Tx beam 426 may be directed away from Eve 414 while still being receivable by the UE 404 using Rx beam 424. Accordingly, the transition to the Tx beam 426 may be transparent to the UE 404, and thus the base station 408 may not inform the UE 404 of the change. The UE 404 may continue to use the existing Rx beam 424 to receive a transmission from the base station 408 that uses the Tx beam 426.

FIG. 4B illustrates another example, in which both the Tx beam and Rx beam are updated. For example, the base station 408 may update the Tx beam from Tx beam 422 to Tx beam 428, and may update the Rx beam from Rx beam 424 to Rx beam 430. The base station 408 may notify the UE of the updated beam information (e.g., Rx beam 430). For example, in some embodiments, the base station may indicate an updated transmission configuration indicator (TCI) state to the UE. The scheme of FIG. 4B may be compatible with unified TCI design.

FIG. 4C illustrates another example in accordance with various embodiments. In this example, the base station modifies Tx beam 422 to generate updated Tx beam 432 that is narrower than Tx beam 422 (also referred to as “beam fining”). The modification of the beam may be transparent to the UE 404, and thus the base station 408 may not notify the UE 404. For example, the UE 404 may continue to use the Rx beam 424.

### UE Mono-Static Sensing-Assisted Beam Forming for Security

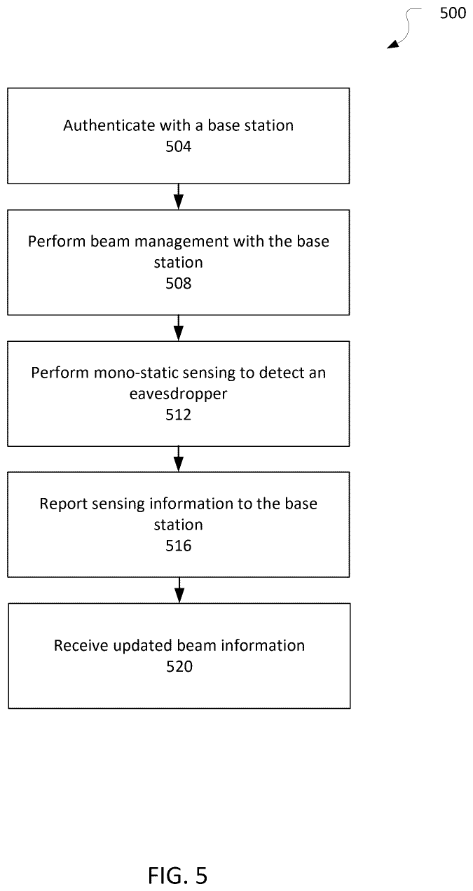

FIG. 5 illustrates an example procedure 500 for UE mono-static sensing-assisted beam forming, in accordance with various embodiments. The procedure 500 is shown in FIG. 5 with reference to operations performed by a UE (e.g., UE 104). Corresponding operations may be performed by base station (e.g., base station 108).

At 504 of the procedure 500, the UE may authenticate with the base station. The authentication may include configuring the security level of sensing-assisted beam forming. Additionally, the UE may send UE capability information to the base station. The UE capability information may indicate UE capability related to sensing, such as a type of sensing supported (e.g., UE mono-static sensing, bi-static sensing, etc.) and/or a sensing schedule of the UE (e.g., a periodicity and/or offset of the sensing schedule).

At 508 of the procedure 500, the UE may perform beam management with the base station. The beam management may be performed to determine beam information to use for communication between the base station and the UE. The beam information may correspond to a Tx beam and an Rx beam.

In embodiments, the beam management may include SSB-based beam management or CSI-RS-based beam management. For example, the UE may perform measurements associated with a respective Tx beams and/or Rx beams and transmit a report to the base station with the measurements. The measurements may include a RSRP, such as a L1-RSRP. The measurements may be performed on a respective SSB or CSI-RS. The base station may select a Tx beam and/or Rx beam to use based on the report. Additionally, the base station may transmit an indication of the selected Rx beam to the UE.

At 512 of the procedure 500, the UE may perform UE mono-static sensing to detect the eavesdropper (Eve). The UE mono-static sensing may be similar to the base station mono-static sensing described above with respect to block 312 of FIG. 3, however, with the UE transmitting and receiving the sensing signal.

At 516 of the procedure 500, the UE may report sensing information to the base station. The sensing information may indicate a location (e.g., two-dimensional and/or three-dimensional coordinates), a direction (e.g., AoA), a type of object, and/or a physical feature of Eve (e.g., size, shape, etc.).

The base station may receive the sensing information and determine updated beam information for the UE based on the sensing information.

At 520 of the procedure 500, the UE may receive, from the base station, updated beam information. The updated beam information may indicate an updated Tx beam and/or an updated Rx beam. In some embodiments, the UE may receive a TCI switching command that corresponds to the updated beam information.

In some embodiments, the UE may report the sensing information as part of beam reporting (e.g., ongoing beam reporting used for beam management as discussed above with respect to block 508). For example, the UE may generate and transmit a report that includes a quality measurement (e.g., L1-RSRP) and sensing information associated with a respective beam. In some embodiments, the sensing information may indicate whether an Eve is detected in association with (e.g., in the direction of) the Tx beam and/or Rx beam. In one example, the sensing information may correspond to a single bit that indicates whether an Eve is detected on either the Tx beam or Rx beam of the beam pair. In another example, the sensing information may include two bits, with a first bit to indicate whether an Eve is detected on the Tx beam and a second bit to indicate whether an Eve is detected on the Rx beam.

In yet another example, the sensing information may include multiple bits (e.g., more than two bits) to indicate more detailed spatial information associated with the detected Eve. For example, a beam may be configured with multiple subsections (e.g., corresponding to respective ranges of AoA and/or other suitable boundaries). In some embodiments, the UE may receive configuration information from the base station to indicate the subsections. The UE may determine whether an Eve is detected in individual subsections of the beam. The sensing information may indicate to the base station whether the Eve was detected in the respective subsections of the beam (e.g., with individual bits corresponding to respective subsections).

In some embodiments, the UE may report the sensing information based on a security level associated with the UE and/or a specific communication. For example, the UE may report the sensing information if the security level is relatively high and may not report the sensing information if the security level is relatively low.

In some embodiments, the UE may receive configuration information from the base station to configure the reporting of the sensing information from the UE to the base station. For example, the UE may be configured to report the sensing information in accordance with periodic, aperiodic, or semi-static CSI reporting. In one example, e.g., for periodic or semi-static CSI reporting, the “reportQuality” field in the information element (IE) of “CSI-ReportConfig” may include a field to configure the reporting of sensing information (e.g., a field of “Sensing” or “cri-RSRP-sensing” or “ssb-Index-RSRP-sensing”). In another example, e.g., for dynamic CSI reporting, the DCI that triggers beam reporting may additionally indicate that the UE is to report the sensing information. In some embodiments, the DCI may include a dedicated field to trigger the report of sensing information. Alternatively, another field, such as “CSI request” field, may jointly indicate for the UE to report the sensing information.

In other embodiments, the UE may send the sensing information in a dedicated message (e.g., separate from beam reporting). For example, the dedicated message may include a medium access control (MAC) control element (CE), an uplink control information (UCI), and/or a RRC message. In some embodiments, the UE may report the sensing information if the UE detects an Eve in the serving beam pair. If the UE detects an Eve in another (inactive) beam pair, the UE may not report it. The reporting may be triggered by an event (e.g., the detection of the Eve and/or a change in security level) or periodic.

In some embodiments, if the UE detects an Eve in the coverage of a beam pair (e.g., the serving beam pair), the UE may request the base station to trigger the reporting of the sensing information (e.g., with or without associated beam measurements). For example, the UE may send a MAC CE, a UCI, and/or a RRC message that includes the request.

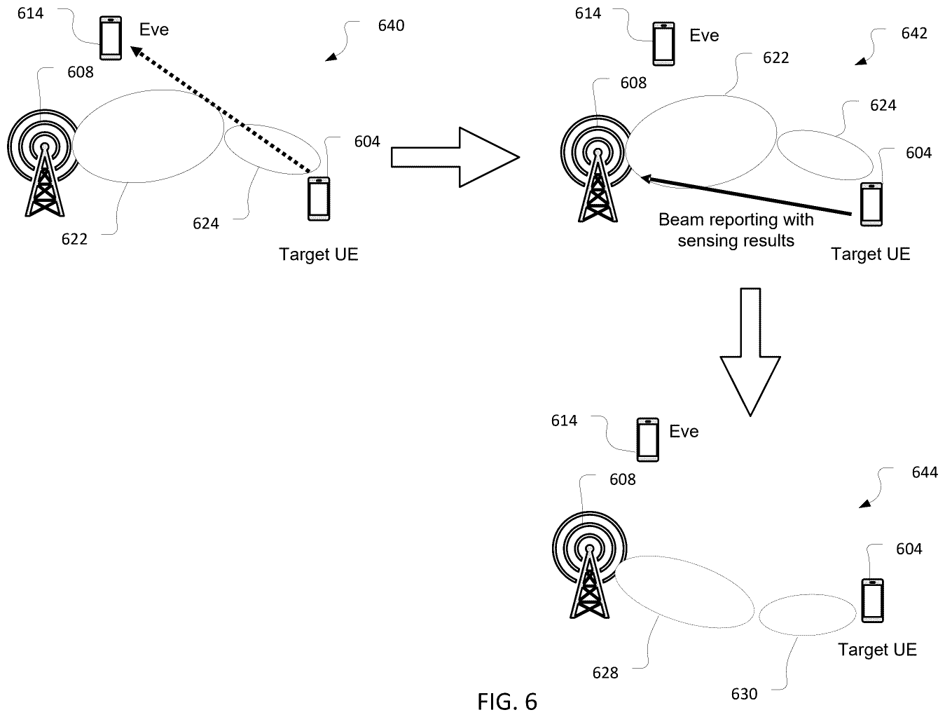

FIG. 6 schematically illustrates one example implementation of UE mono-static sensing-assisted beam forming, in accordance with various embodiments. As shown at 640, a base station 608 (e.g., corresponding to base station 108) may communicate with a UE 604 (e.g., corresponding to UE 104) using a Tx beam 622 and an Rx beam 624. The UE 604 may perform mono-static sensing and thereby detect the presence of Eve 614 (e.g., in the coverage area of Tx beam 622 and/or Rx beam 624). The UE 604 may generate sensing information that indicates the presence of Eve 614.

At 642, the UE 604 may report the sensing information to the base station 608. The base station 608 may determine updated beam information and indicate the updated beam information to the UE 604.

At 644, the base station 608 and UE 604 may use the updated beam information, corresponding to Tx beam 628 and Rx beam 630. The updated beam information may prevent or reduce the likelihood that the Eve 614 will receive the transmission.

### Bi-Static Sensing-Assisted Beam Forming

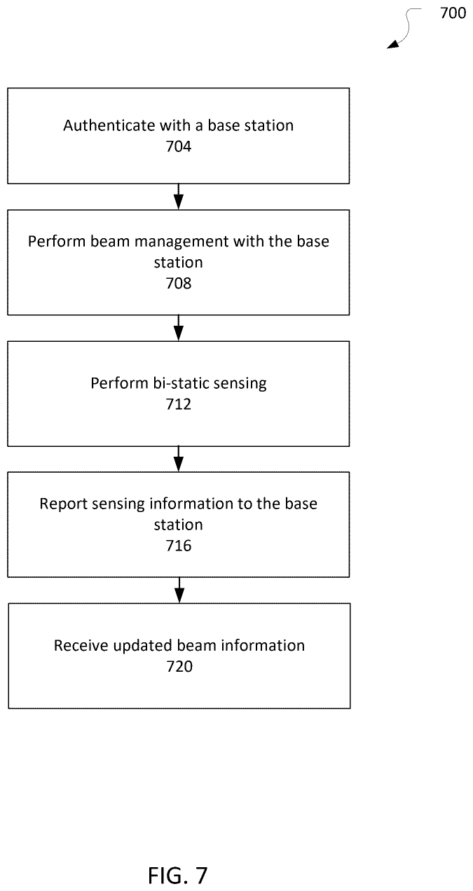

FIG. 7 illustrates an example procedure 700 for base station-UE bi-static sensing-assisted beam forming, in accordance with various embodiments. A similar procedure may be performed for UE-base station bi-static sensing and/or other types of bi-static sensing (e.g., base station-base station bi-static sensing or UE-UE bi-static sensing). The procedure 700 is shown in FIG. 7 with reference to operations performed by a UE (e.g., UE 104). Corresponding operations may be performed by base station (e.g., base station 108).

At 704 of the procedure 700, the UE may authenticate with the base station. The authentication may include configuring the security level of sensing-assisted beam forming. Additionally, the UE may send UE capability information to the base station. The UE capability information may indicate that the UE is capable of bi-static sensing (e.g., base station-UE bi-static sensing) and/or a sensing schedule of the UE (e.g., a periodicity and/or offset of the sensing schedule).

At 708 of the procedure 700, the UE may perform beam management with the base station. The beam management may be performed to determine beam information to use for communication between the base station and the UE. The beam information may correspond to a Tx beam and an Rx beam. In embodiments, the beam management may include SSB-based beam management or CSI-RS-based beam management.

At 712 of the procedure 700, the UE may perform bi-static sensing. For example, the UE may receive a sensing signal that is transmitted by the base station. The UE may process the received sensing signal to generate sensing information as described herein.

In embodiments, the UE may receive configuration information from the base station to configure the bi-static sensing. For example, the configuration information may configure a measurement gap during which the UE is to perform the sensing and/or provide other parameters associated with the sensing signal.

At 716 of the procedure 700, the UE may report the sensing information to the base station. The report of the sensing information may be similar to the reporting described above with reference to UE mono-static sensing (e.g., at block 516 of FIG. 5).

At 720 of the procedure 700, the UE may receive updated beam information from the base station. The updated beam information may indicate an updated Tx beam and/or an updated Rx beam. In some embodiments, the updated beam information may correspond to a TCI switching command.

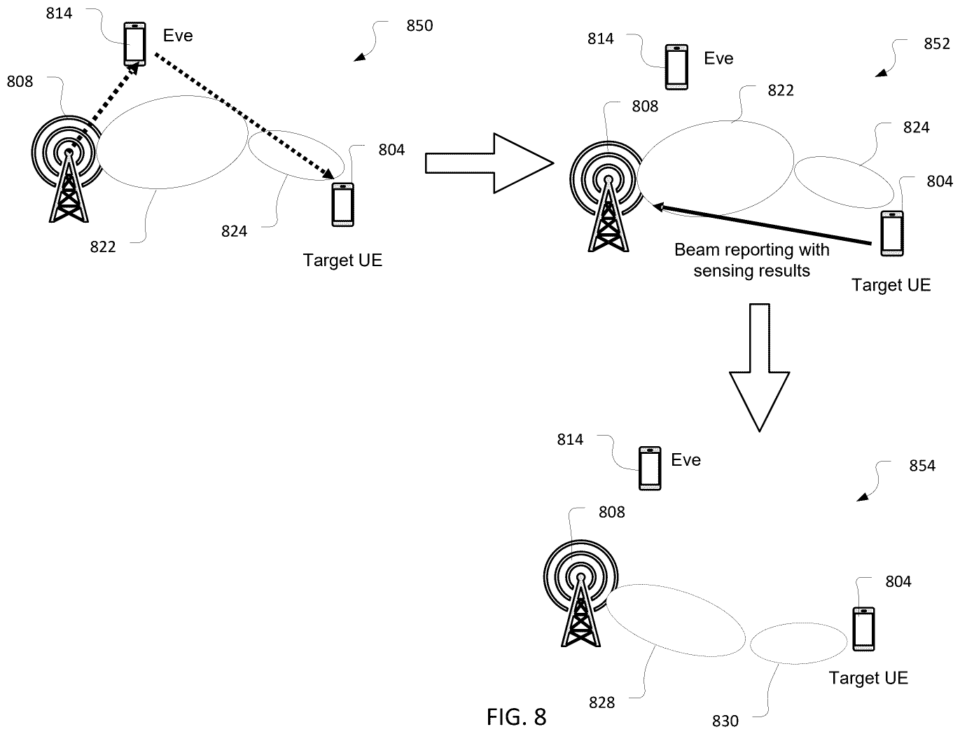

FIG. 8 schematically illustrates one example implementation of base station-UE bi-static sensing-assisted beam forming, in accordance with various embodiments. As shown at 850, a base station 808 (e.g., corresponding to base station 108) may communicate with a target UE 804 (e.g., corresponding to UE 804) using a Tx beam 822 and an Rx beam 824. The base station 808 transmits a sensing signal that is received by the UE 804. The UE 804 may generate sensing information based on the received sensing signal. The sensing information may indicate the presence of Eve 814 (e.g., in the coverage area of Tx beam 822 and/or Rx beam 824).

At 852, the UE 804 may report the sensing information to the base station 808. The base station 808 may determine updated beam information and indicate the updated beam information to the UE 804.

At 854, the base station 808 and UE 804 may use the updated beam information, corresponding to Tx beam 828 and Rx beam 830. The updated beam information may prevent or reduce the likelihood that the Eve 814 will receive the transmission.

### Example Operational Flows/Algorithmic Structures

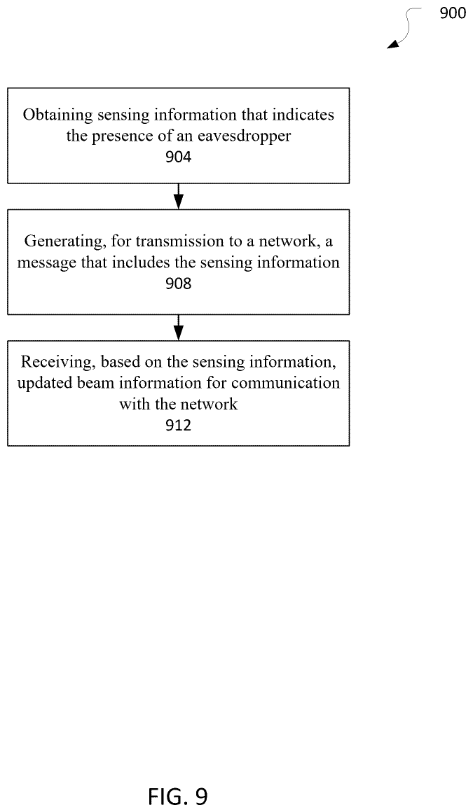

FIG. 9 is an operational flow/algorithmic structure 900 for sensing-assisted beamforming in accordance with some embodiments. The operational flow/algorithmic structure 900 may be implemented by a UE such as, for example, UE 104, UE 1400, or components thereof; for example, a baseband processor 1404A.

The operation flow/algorithmic structure 900 may include, at 904, obtaining sensing information that indicates the presence of an eavesdropper. The sensing information may be, for example, mono-static sensing information and/or bi-static sensing information. In some embodiments, the sensing information may indicate the presence of the eavesdropper on one or more beams (e.g., transmit beams and/or receive beams). The one or more beams may be configured as candidate beams for communication between the network and the UE.

The operational flow/algorithmic structure 900 may further include, at 908, generating, for transmission to a network, a message that includes the sensing information. In some embodiments, the message may further include one or more beam measurements.

The operational flow/algorithmic structure 900 may further include, at 912, receiving, based on the sensing information, updated beam information for communication with the network. For example, the updated beam information may indicate a receive beam and/or a transmit beam on which the eavesdropper is not detected based on the sensing information.

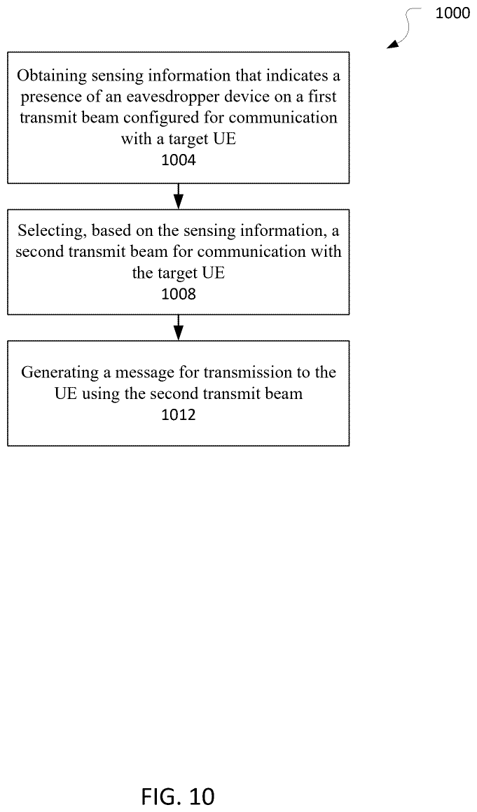

FIG. 10 is another operational flow/algorithmic structure 1000 in accordance with some embodiments. The operational flow/algorithmic structure 1000 may be performed by a base station, such as base station 108, network device 1500, or components thereof, for example, processors 1504A.

The operational flow/algorithmic structure 1000 may include, at 1004, obtaining sensing information that indicates a presence of an eavesdropper device on a first transmit beam configured for communication with a target UE. The sensing information may include any suitable type of sensing information, such as base station mono-static sensing information, UE mono-static sensing information (e.g., received from the target UE and/or another UE), and/or bi-static sensing information. The sensing information may indicate whether the eavesdropper is detected on one or more candidate beams (e.g., transmit beams and/or receive beams).

The operational flow/algorithmic structure 1000 may further include, at 1008, selecting, based on the sensing information, a second transmit beam for communication with the target UE. For example, the second transmit beam may be the candidate beam with the best quality (e.g., highest measurement value, such as RSRP) among candidate beams for which the eavesdropper is not detected (e.g., based on the sensing information).

The operational flow/algorithmic structure 1000 may further include, at 1012, generating a message for transmission to the UE using the second transmit beam. In some embodiments, the base station may transition from using the first transmit beam to using the second transmit beam for downlink communication with the UE. In some embodiments, the transition may be transparent to the UE (e.g., the UE may continue to use the same receive beam). In other embodiments, the base station may indicate an updated receive beam to the UE for the UE to use to receive the message.

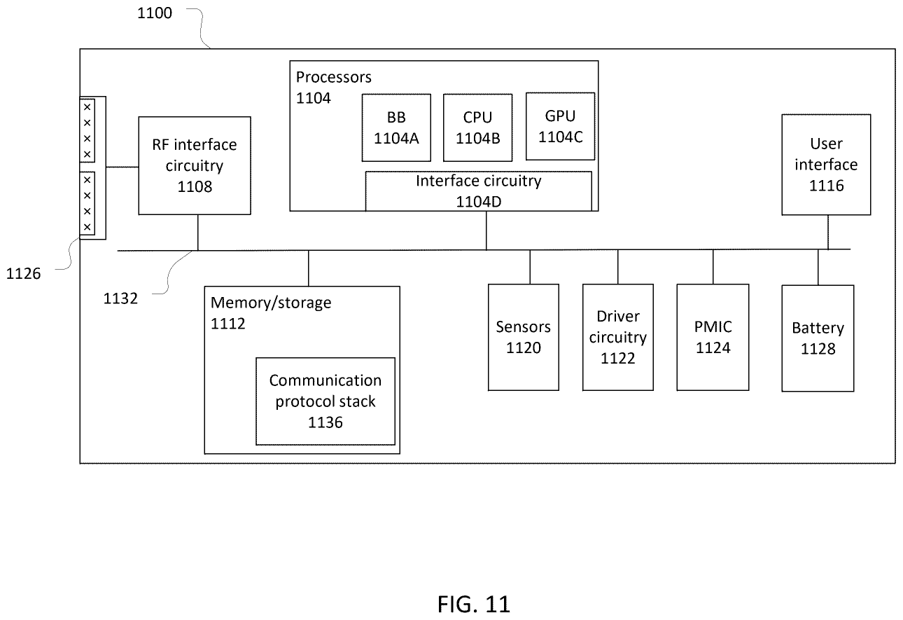

FIG. 11 illustrates a UE 1100 in accordance with some embodiments. The UE 1100 may be similar to and substantially interchangeable with UE 104.

The UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1100 may include processors 1104, RF interface circuitry 1108, memory/storage 1112, user interface 1116, sensors 1120, driver circuitry 1122, power management integrated circuit (PMIC) 1124, antenna 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, or optical connection that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform operations as described herein (e.g., operations associated with sensing-assisted beamforming). The processors 1104 may also include interface circuitry 1104D to enable communication by, for example, communicatively coupling the processor circuitry with one or more other components of the UE 1100.

In some embodiments, the baseband processor 1104A may access a communication protocol stack 1136 in the memory/storage 1112 to communicate over a 3GPP compatible network. In general, the baseband processor 1104A may access the communication protocol stack 1136 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1108.

The baseband processor 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the UE 1100 to perform operations as described herein (e.g., operations associated with sensing-assisted beamforming).

The memory/storage 1112 includes any type of volatile or non-volatile memory that may be distributed throughout the UE 1100. In some embodiments, some of the memory/storage 1112 may be located on the processors 1104 themselves (for example, memory/storage 1112 may be part of a chipset that corresponds to the baseband processor 1104A), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include antenna elements to convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, or phased array antennas. The antenna 1126 may have one or more panels designed for specific frequency bands including bands in FR1 or FR2.

The user interface 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1100.

The sensors 1120 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensors 1120 and control and allow access to sensors 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

A battery 1128 may power the UE 1100, although in some examples the UE 1100 may be mounted deployed in a fixed location and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

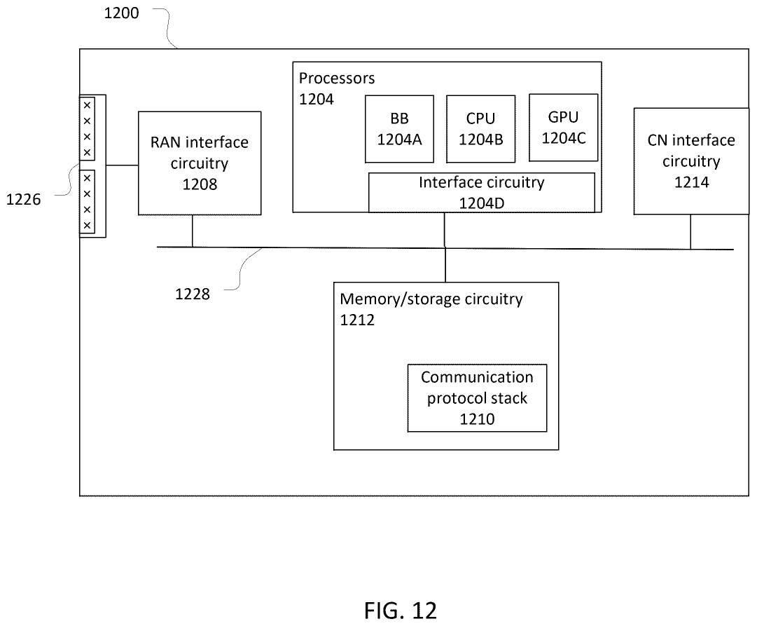

FIG. 12 illustrates a network device 1200 in accordance with some embodiments. The network device 1200 may be similar to, and substantially interchangeable with, the base station 108 and/or a component of the CN 112.

The network device 1200 may include processors 1204, RF interface circuitry 1208 (if implemented as a base station), core network (CN) interface circuitry 1214, memory/storage circuitry 1212, and antenna structure 1226.

The components of the network device 1200 may be coupled with various other components over one or more interconnects 1228.

The processors 1204, RF interface circuitry 1208, memory/storage circuitry 1212 (including communication protocol stack 1210), antenna structure 1226, and interconnects 1228 may be similar to like-named elements shown and described with respect to FIG. 11.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage circuitry 1212 to cause the network device 1200 to perform operations as described herein (e.g., operations associated with sensing-assisted beamforming). The processors 1204 may also include interface circuitry 1204D to communicatively couple the processor circuitry with one or more other components of the network device 1200.

The CN interface circuitry 1214 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1200 via a fiber optic or wireless backhaul. The CN interface circuitry 1214 may include one or more dedicated processors or FPGAs to communicate using one or more of the aforementioned protocols. In some implementations, the CN interface circuitry 1214 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method comprising: obtaining sensing information that indicates a presence of an eavesdropper device on a first transmit beam configured for communication with a user equipment (UE); selecting, based on the sensing information, a second transmit beam for communication with the UE; and generating a message for transmission to the UE using the second transmit beam.

Example 2 may include the method of example 1, further comprising: selecting, based on the sensing information, a receive beam for the UE to use to receive the message; and generating, for transmission to the UE, an indication of the receive beam.

Example 3 may include the method of example 1, further comprising transitioning communication with the UE from the first transmit beam to the second transmit beam.

Example 4 may include the method of example 3, wherein the transition is transparent to the UE.

Example 5 may include the method of example 3, wherein the second transmit beam is narrower than the first transmit beam.

Example 6 may include the method of example 1, wherein the sensing information is base station mono-static sensing information.

Example 7 may include the method of example 1, wherein the sensing information is obtained from the UE.

Example 8 may include the method of example 1, wherein the selecting the second transmit beam is performed based on a security profile associated with the UE.

Example 9 may include the method of example 1, wherein the second transmit beam applies to a subset of downlink transmissions to the UE.

Example 10 may include the method of example 1, wherein the sensing information indicates a sub-section of the first transmit beam on which the eavesdropper is detected.

Example 11 may include a method comprising: obtaining sensing information that indicates the presence of an eavesdropper; generating, for transmission to a network, a message that includes the sensing information; and receiving, based on the sensing information, updated beam information for communication with the network.

Example 12 may include the method of example 11, wherein the updated beam information includes receive beam information.

Example 13 may include the method of example 11, wherein the message further includes a measurement of a beam.

Example 14 may include the method of example 11, wherein the sensing information indicates that the eavesdropper is detected for a first beam and not detected for a second beam.

Example 15 may include the method of example 14, wherein the sensing information indicates a sub-section of the first beam on which the eavesdropper is detected.

Example 16 may include the method of example 13, further comprising receiving configuration information to indicate whether the sensing information is to be included in the message with the measurement.

Example 17 may include the method of example 11, wherein the message is dedicated for reporting of the sensing information, and wherein the sensing information indicates that the presence of the eavesdropper was detected on an active transmit beam or receive beam.

Example 18 may include the method of example 11, further comprising generating user equipment (UE) capability information for transmission to the network, wherein the UE capability information indicates a capability to perform the sensing.

Example 19 may include the method of example 18, wherein the UE capability information further indicates a periodicity and offset of a sensing schedule, and whether mono-static sensing or bi-static sensing are supported.

Example 20 may include the method of example 11, wherein the message is transmitted to the network based on a security level of a user equipment (UE).

Example 21 may include the method of example 11, further comprising applying the updated beam information for receipt of a subset of downlink transmissions from the base station, wherein the subset includes a data transmission.

Example 22 may include a baseband processor comprising: processor circuitry to: receive beam measurements for a set of candidate beams configured for a user equipment (UE); activate, based on the beam measurements, a first beam for communication with the UE; obtain sensing information that indicates a presence of an eavesdropper device on the first beam; and activate, based on the sensing information, a second beam for communication with the UE. The baseband processor may further comprise interface circuitry coupled with the processor circuitry, the interface circuitry to communicatively couple the processor circuitry to a component of a device.

Example 23 may include the baseband processor of example 22, wherein the processor circuitry is further to generate a message for transmission to the UE using the second beam.

Example 24 may include the baseband processor of example 22, wherein the second beam includes a transmit beam or a receive beam.

Example 25 may include the baseband processor of example 24, wherein the second beam includes the receive beam, and wherein the processor circuitry is further to generate a message, for transmission to the UE, to activate the receive beam.

Example 26 may include the baseband processor of example 22, wherein the second beam is narrower than the first beam.

Example 27 may include the baseband processor of example 22, wherein the sensing information is base station mono-static sensing information.

Example 28 may include the baseband processor of example 22, wherein the sensing information is obtained from the UE.

Example 29 may include the baseband processor of example 28, wherein, to obtain the sensing information, the processor circuitry is to decode a report that also includes updated beam measurements.

Example 30 may include the baseband processor of example 22, wherein the second beam is activated based on a security profile associated with the UE.

Example 31 may include the baseband processor of example 22, wherein the second beam is activated for a subset of downlink or uplink communication with the UE.

Example 32 may include the baseband processor of example 22, wherein the sensing information indicates a sub-section of the first beam on which the eavesdropper is detected.

Another example may include an apparatus comprising means to perform one or more elements of a method described in or related to any of examples 1-32, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example may include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated.

What is claimed is:

1. A method comprising:
obtaining sensing information that indicates a presence of an eavesdropper device on a first transmit beam configured for communication with a user equipment (UE);
selecting, based on the sensing information, a second transmit beam for communication with the UE; and
generating a message for transmission to the UE using the second transmit beam.

2. The method of claim 1, further comprising:
selecting, based on the sensing information, a receive beam for the UE to use to receive the message; and
generating, for transmission to the UE, an indication of the receive beam.

3. The method of claim 1, further comprising transitioning communication with the UE from the first transmit beam to the second transmit beam, wherein the transition is transparent to the UE.

4. The method of claim 1, wherein the second transmit beam is narrower than the first transmit beam.

5. The method of claim 1, wherein the sensing information is base station mono-static sensing information, or wherein the sensing information is obtained from the UE.

6. The method of claim 1, wherein the selecting the second transmit beam is performed based on a security profile associated with the UE.

7. The method of claim 1, wherein the second transmit beam applies to a subset of downlink transmissions to the UE.

8. The method of claim 1, wherein the sensing information indicates a sub-section of the first transmit beam on which the eavesdropper is detected.

9. A method comprising:
obtaining sensing information that indicates the presence of an eavesdropper;
generating, for transmission to a network, a message that includes the sensing information; and
receiving, based on the sensing information, updated beam information for communication with the network.

10. The method of claim 9, wherein the updated beam information includes receive beam information.

11. The method of claim 9, wherein the message further includes a measurement of a beam, and wherein the method further comprises receiving configuration information to indicate whether the sensing information is to be included in the message with the measurement.

12. The method of claim 9, wherein the sensing information indicates that the eavesdropper is detected for a first beam and not detected for a second beam.

13. The method of claim 12, wherein the sensing information indicates a sub-section of the first beam on which the eavesdropper is detected.

14. The method of claim 9, wherein the message is dedicated for reporting of the sensing information, and wherein the sensing information indicates that the presence of the eavesdropper was detected on an active transmit beam or receive beam.

15. The method of claim 9, further comprising generating user equipment (UE) capability information for transmission to the network, wherein the UE capability information indicates a periodicity and offset of a sensing schedule, and whether mono-static sensing or bi-static sensing are supported.

16. The method of claim 9, wherein:
the message is transmitted to the network based on a security level of a user equipment (UE); or
the updated beam information is to be applied for receipt of a subset of downlink transmissions from a base station of the network, wherein the subset includes a data transmission.

17. An apparatus comprising:
processor circuitry to:
receive beam measurements for a set of candidate beams configured for a user equipment (UE);
activate, based on the beam measurements, a first beam for communication with the UE;
obtain sensing information that indicates a presence of an eavesdropper device on the first beam;
determine, based on the sensing information, a second beam for communication with the UE, wherein the second beam includes a transmit beam or a receive beam; and
generate a message for transmission to the UE using the transmit beam or generate a message for transmission to the UE to activate the receive beam; and
interface circuitry coupled with the processor circuitry to enable communication.

18. The apparatus of claim 17, wherein the sensing information indicates a sub-section of the first beam on which the eavesdropper is detected, and wherein the second beam is narrower than the first beam.

19. The apparatus of claim 17, wherein the second beam is determined based on a security profile associated with the UE.

20. The apparatus of claim 17, wherein the second beam is activated for a subset of downlink or uplink communication with the UE.
